(19) United States
(12) Patent Application Publication
(10) Pub. No.: US 2014/0379507 A1
(43) Pub. Date: Dec. 25, 2014

(54) System of Multi-Functional Ecommerce websites each with an integrated shopping cart, a catalog of products from drop shippers or suppliers of any type, a secure payment processing gateway, a real-time merchant account activation module, a website builder that creates custom or duplicate websites with a URL, and a centralized content management module capable of modifying web-site-content to each website in the system.

(71) Applicant: Alexy Pitt, Irvine, CA (US)

(72) Inventor: Alexy Pitt, Irvine, CA (US)

(21) Appl. No.: 13/927,032

(22) Filed: Jun. 25, 2013

(51) Int. Cl. G06Q 30/06

(52) U.S. Cl. CPC G06Q 30/0601
USPC 705/26.1

(57) ABSTRACT

A system and method of creating Ecommerce web sites which are fully integrated with products for sale, a shopping cart, and a merchant account. The created Ecommerce websites include a site builder module capable of creating other Ecommerce websites. This functionality allows a website to be partially duplicated, the partially duplicated websites having their own URL.

A system of Multi-Functional Ecommerce websites each with an integrated shopping cart, a catalog of products from drop shippers or suppliers of any type, a secure payment processing gateway, a real-time merchant account activation module, a website builder that creates custom or duplicate websites with a URL, and a centralized content management module capable of modifying web-site-content to each website in the system.

### CROSS REFERENCE TO RELATED APPLICATIONS

None.

### STATEMENT OF FEDERALLY SPONSORED RESEARCH/DEVELOPMENT

Not Applicable

### REFERENCE TO SEQUENCE LISTING, A TABLE, OR A COMPUTER PROGRAM LISTING COMPACT DISK APPENDIX

Not Applicable

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

The internet has changed the world. Entire industries have come into existence because of the internet. These industries can provide access to a variety of types of content (e.g. news, entertainment, correspondence, etc.) But besides using the internet as a means to provide content or network socially, the internet has created an entirely new way to conduct business. Facilitating commerce via the internet is commonly known as ecommerce.

Some businesses believe that by just having a website on the internet, that their website is going to be effective at reaching customers anywhere in the world. Unfortunately these novice businessmen are mistaken. A single website is easily “lost” in the millions upon millions of websites available on the internet. Search engines such as “Google®” and “Yahoo®” systematically index and rank websites to determine the order which websites are displayed as the result of a search. A new ecommerce business with a single website and very little presence on the web will not be on the first page of search results. This new business can try various techniques to drive traffic to its website, some techniques include Search Engine Optimization and purchasing key words from the search engine. These two techniques focus on the words and phrases that people place into a search engine. These techniques are well known and easily duplicated and therefore do not provide a true competitive advantage to a business.

Even if a new ecommerce business is found in a search, the new business must be ready to process a customer transaction. As credit cards are the payment method of choice, an ecommerce business will need a merchant account.

Myriad patents relating to creating an ecommerce website already exist. Myriad patents on methods to obtain a merchant account as well already exist. A new method and system of creating a franchise of ecommerce businesses is needed where businesses can obtain a greater presence on the internet by having multiple web sites and be ready to process transactions immediately.

1. Field of the Disclosure

The field of the disclosure includes apparatus and methods for developing a network of ecommerce websites, each website including, but not limited to, a shopping cart, a payment system and a merchant account.

2. Description of Related Art

For a retail business to sell products via the internet a variety of arrangements must be made. Generally, the arrangements apply to three interrelated categories: 1. Products, 2. Payments, and 3. Web-site.

### Products

Whether it's a traditional “brick and mortar” store or an internet based “click and mortar” store, a retail business must have a product (or products) to sell. This product may come from a separate product manufacturer or in some instances the retail business may also be the product manufacturer. Either way, there must be a product for the customer to purchase. Traditionally, a product manufacturer warehoused the products prior to shipping the product to the customer. A retail business may decide to warehouse some products at its place of business. Depending on the business, this place could be a rental space in a huge mall or the spare bed room in the business owner's home. Finally, the retail business must arrange to have the product shipped to a location (e.g. the retail store, a customer's residence, some other residence chosen by a customer.)

The use of drop-shippers to eliminate the need for a business to store and manage an inventory of products in its warehouse has become popular. This is when the warehouse (not co-located with the business) also facilitates the shipping, thereby the product is never physically located at the place of business. The product manufacturer may warehouse the products and fulfill orders or the product manufacturer out-sources the fulfillment process to a third party to conduct the order fulfillment. A business owner can focus on marketing, networking, and customer relations instead of tracking inventory and fulfilling customer orders.

### Payments

Receiving payment for products poses a slight dilemma for a retail ecommerce business. The retail business can not accept cash via the internet. The business could accept checks, but considering the time it takes to mail a check, deposit the check, and wait for the check to clear, accepting checks for purchases over the internet is also problematic. Electronic systems to provide rapid transactions over great distances have been developed. The Automated Clearing House (ACH) is one such system that has been developed by the financial industry.

One of the new businesses that has been created because of the internet is the on-line payment service provider. An on-line payment service provider offers ecommerce retail businesses online services for accepting electronic payments by a variety of payment methods including credit cards, bank-based payments such as direct debit, bank transfer, and real-time bank transfer based on online banking. Probably the most popular payment service provider is PayPal®. Though the payment service provider provides a valuable service to an ecommerce business, the service is not free. Payment service providers can charge the ecommerce business based on the number of transactions processed or on the value of the transaction processed or both. Furthermore, the ecommerce business may not have access to the funds until the end of a business cycle (e.g. the end of the month.) During this time, the payment service provider maintains possession of the funds and collects interest on the funds, while the on-line business's cash flow is clogged.

The ability to accept a credit card diminishes (if not totally eliminates) the need for an ecommerce business to use a payment service provider. Still, not all ecommerce businesses can accept credit cards and even if an ecommerce business can accept credit cards it may still want to provide other payment options to its customers who may not have a credit card. The ecommerce business must have a merchant account if it is going to be able to process a credit card transaction. Banks that issue credit cards only transfer funds to merchant accounts; the bank will not transfer funds to an individual's personal account or even a business account.

Though having a merchant account is extremely valuable for an ecommerce business, obtaining a merchant account is not guaranteed. Banks issue merchant accounts only when the situation merits it. The merchant account helps defend against fraudulent purchases. An ecommerce business (or any business) is required to justify to the bank issuing the merchant account that it is worthy of receiving the merchant account. Though the exact calculus of what makes a retail business worthy of a merchant account varies from bank to bank, a bank will invariably examine the viability and reliability of the retail business, e.g. what products does the business sell? How many products does the business sell? Who are the business's suppliers? Does the business have the ability to fulfill customer orders? How many product returns has the business had? How long has the business existed? A score is generated based on the responses and the decision to authorize or reject the merchant account application is made.

### Web-Site

The very first step in creating a website is to obtain a domain name (e.g. www.businessstore.com.) Purchasing a domain name is simple since there are a variety of businesses which specialize in selling domain names (e.g. GoDaddy.com®) If the domain name is available, it can typically be purchased.

The retail business must then find a website hosting service to host the site. Web hosts provide space for a business to place the files that make up its website on an internet connected server. Now the retail business is ready to design its website. A business can hire a professional website designer, or purchase a website designing software in order to design it, or even purchase a relatively generic but upgradable design on line.

Designing entails, where the company name and logo are placed, placement of photos, placement of contact information, placement of videos, links to other sites, etc. In general the website design is what a person who visits the website sees and hears.

But to sell products on-line an ecommerce business website must have a shopping cart. A shopping cart is a piece of ecommerce software on a web server that allows visitors to the website to select products for eventual purchase. The software allows online purchasers to accumulate a list of items for purchase. Upon checkout, the software typically calculates a total for the order, including shipping and handling (e.g. postage and packing) charges and the associated taxes, as applicable. An ecommerce business will have to go through the process of populating its shopping cart with the products it is offering for sale.

An ecommerce business seeking to obtain a website may forego coordinating designing a website, obtaining a URL, integrating a shopping cart, obtaining merchant account, etc. and instead use a pre-packaged store from a website such as Amazon® or Ebay®. These pre-packaged stores, though convenient, do not eliminate all of the expenses for the ecommerce business. The retail business is required to abide by the rules of the site, and pay the store a fee. Furthermore, a business does not have its own domain name or URL. The business uses a website on the pre-packaged store's domain (e.g. www.stores.ebay.com/retailbusiness)

Financial barriers, administrative barriers, and the time it takes to overcome the barriers, stifle the creation of ecommerce businesses and limit the expansion of ecommerce businesses. The ability to create ecommerce businesses, each with a website, shopping cart populated with products, a merchant account, and its own URL is needed. Also, a system of updating content across all of the newly created ecommerce websites is needed.

### BRIEF SUMMARY

In a first aspect of the disclosure, a network apparatus is disclosed. In one embodiment the network apparatus configured to create Ecommerce websites for customers in communication therewith, the network apparatus comprising: a first network interface in data communication with a server; a second network interface in data communication with the server; and a third network interface in data communication with the server via a first Ecommerce website; wherein the server is configured to: receive via the first network interface data input by a first customer, the data relating to the first Ecommerce website; receive via the second network interface data input by at least a first supplier, the data input relating to products the at least first supplier is offering for sale; receive via the third network interface data input by a second customer, the data relating to a second Ecommerce website; wherein the server comprises: a product inventory module adapted to receive, store and transmit the data related to products the at least first supplier is offering for sale; a first site builder module adapted to create at least one Ecommerce website hosted on the server; the first Ecommerce website.

In one variant, the first Ecommerce website comprises: a second site builder module adapted to create at least an Ecommerce website hosted on the server, the second site builder module in data communication with the product inventory module, a first payment page, a first website front end, a first shopping cart, a first content management system, a first On-Line Boarding Application module, a first preset product data module, the first preset product data module is related to the data input by the first customer and the data related to products the at least first supplier is offering for sale.

In another variant the first On-Line Boarding Application module is configured to produce at least a first document, the first document being an agreement between the first customer and the first supplier to establish business arrangement between the first customer and the first supplier.

In a second aspect of the disclosure, a method of creating ecommerce websites is disclosed. In one embodiment, the method comprises: providing a first person with a first website, wherein the first website includes a first website building module capable of creating at least another website; using the first website building module of the first website to create at least a second website, wherein the second website includes a portion of data from the first website and a second website building module capable of creating at least another website; and giving control of the second website to a second person.

In one variant, the method further comprises: using the second website building module to create at least a third website, wherein the third web site includes a portion of content from the second web site and a third web site building module capable of creating at least another website; and giving control of the third website to a third person.

In another variant, the portion of data from the first web site comprises product inventory data.

In still another variant the portion of data from the first website comprises a shopping cart.

In still yet another variant the portion of data from the first website comprises an image file.

In a third aspect of the disclosure, a method of updating content on a system of Ecommerce websites located on the same server is disclosed. In one embodiment, the method of updating content on a system of Ecommerce websites located on the same server comprises: creating a first website, wherein the first web site includes a software module capable of creating at least another website; creating at least a second website, wherein location data of files making up the at least second website are in the files of the first website; using a content management system located on the first website to update content on the first website; and using the location data of files making up the at least second web site to allow the content management system located on the first website to update content of the at least second website.

In one variant, the first website has a first URL; and the at least second website has a second URL.

In a fourth aspect of the disclosure, a method of processing documents related to the functioning of a fully integrated Ecommerce website is disclosed. In one embodiment, the method of processing documents related to the functioning of a fully integrated Ecommerce website comprises: accessing via a network a website, the website adapted to create Ecommerce websites; inputting identification data, the data related to a person creating an ecommerce website; storing the identification data on a server; providing a selectable list of business types; selecting a business type from the selectable list of business types; confirming the identification data; confirming the business type; generating, based in part on the identification data and the business type, the files that comprise a website corresponding to the business type; storing the files that comprise a website on the server; generating a partially completed document, the completed parts of the document related to the identification data and the business type; inputting data to complete the document; providing an electronic signature; evaluating the document, wherein the evaluating is influenced by the identification and the business type; and based on the results of the evaluating the document, creating an output;

In one variant, the document is a merchant account application; and the output is a merchant account.

In another variant, the evaluating the document further comprises the steps of: comparing the identification data to a negative database; comparing the identification data to a credit report; comparing the identification data to the Lexus Nexus database;

In still another variant, the method further comprises the steps of: integrating the merchant account into the files that comprise a website corresponding to the business type; creating a terminal Identification Number; activating the merchant account on a network; and generating a log-in to a virtual terminal located on a server.

In yet another variant, the document is an agreement between a supplier and a customer; and the output is a customer account.

In another variant, the method further comprises the steps of: providing the agreement to the supplier, wherein the agreement comprises data to facilitate electronic transactions between the supplier and the customer.

In still yet another variant, the document is a bank account application; and the output is a bank account.

### BRIEF DESCRIPTION OF THE DRAWINGS

The features, objectives, and advantages of the invention will become more apparent from the detailed description set forth below when taken in conjunction with the drawings, wherein:

FIG. 1 is a graphic representation of a computer network system capable of producing ecommerce websites.

FIG. 1A is a graphic representation of a computer network system capable of facilitating drop shipping of products.

FIG. 2 is a graphic representation of a network of related ecommerce websites.

FIG. 3 is a graphic representation of screen shot from an ecommerce website created by a content management system.

FIG. 3A is a graphic representation of a network of related ecommerce websites.

FIG. 4 is a flow chart representing a method for processing documents.

FIG. 4A is a flow chart representing a method for process a Merchant Account application.

FIG. 4B is a flow chart representing a method for processing a Bank Account application.

FIG. 4C is a flow chart representing a method for processing a Supplier Agreement.

Other features and advantages of the present invention will immediately be recognized by persons of ordinary skill in the art with reference to the attached drawings and detailed description of exemplary embodiments as given below.

### DETAILED DESCRIPTION

Reference is now made to the drawings wherein like numerals refer to like parts throughout.

### Definitions of Key Terms

As used herein, the term “content management system” refers to a computer software application adapted to, among other things, upload, edit, and manage content displayed on a website. A content management system can perform a variety of different tasks for a website including, but not limited to, regulating when content is displayed, how many times the content is shown to a specific user, and managing how the content connects or interacts with other elements of the web site. A person can “drag and drop” portions of the website or change colors of content with the use of the content management system. The content management system also enables less technical individuals to manage content on a website.

As used herein, the term “Customer” refers to generally an individual. The “Customer” may also be an individual acting on behalf of a business entity (e.g. Corporation, Limited Liability Company, etc.) The Customer may be an employee, independent contractor, or related to the business entity in some way. It is contemplated that the “Customer” may even be a software module adapted to enter the responses a person would enter.

As used herein, the term “merchant service provider” is a bank or other firm that can provide processing for credit card transactions. A merchant service provider typically provides entities or individuals a merchant account.

As used herein, the term “online merchant application” or “OLMA” is an electronic form presented to and completed by a Customer. The form, when completed, is reviewed by a merchant service provide and evaluated to determine if the Customer is worthy of having a merchant account.

As used herein, the term “payment gateway” refers to a software module authorizes payments for ecommerce businesses, online retailers, or traditional retailers. The payment gateway protects credit card details by encrypting sensitive information, such as credit card numbers, to ensure that information is passed securely between a customer and the merchant and also between merchant and the payment processor. As used herein, the term “shopping cart” refers to ecommerce software on a web server that allows visitors to a website to select items for eventual purchase. The shopping cart allows online shopping customers to accumulate a list of items for purchase. Upon checkout, the shopping cart can calculate a variety of data related to the order, amongst which are shipping and handling (e.g. postage and packing) charges and the associated taxes, as applicable.

As used herein, the term “Site Builder” refers to, generally, a computer software application capable of constructing websites without manual code editing. The websites are generally created using either HTML or Adobe Flash. For the purposes of this disclosure, either HTML or Adobe Flash may be used. In the preferred

As used herein, the term “software” or “program” or “module” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

As used herein, the term “display” means any type of device adapted to display information, including without limitation: CRTs, LCDs, TFTs, plasma displays, LEDs, incandescent and fluorescent devices. Display devices may also include less dynamic devices such as, for example, printers, e-ink devices, and the like.

As used herein, the term “network” refer generally to any type of data, telecommunications or other network including, without limitation, data networks (including MANs, PANs, WANs, LANs, WLANs, micronets, piconets, internets, and intranets), hybrid fiber coax (HFC) networks, satellite networks, cellular networks, and telco networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, 802.11, 802.20, ATM, X.25, Frame Relay, 3GPP, 3GPP2, WAP, SIP, UDP, FTP, RTP/RTCP, H.323, etc.).

As used herein, the term “server” refers to any computerized component, system or entity regardless of form which is adapted to provide or execute data, files, applications, software, content, or other services to one or more other devices or entities on a computer network.

As used herein, the term “uniform resource locator” or “URL” refers to a specific character string that constitutes a reference to a resource. In most web browsers, the URL of a web page is displayed on top inside an address bar. An example of a typical URL would be “http://en.example.org/Patent_Application”.

### Overview

The disclosed method and apparatus allows one or more users to create fully functioning ecommerce businesses, each with a website, an integrated shopping cart populated with products available for sale, a merchant account, and a payment system. Furthermore, the method and apparatus allows a particular user to update content on the multiple user-created ecommerce business websites.

### DETAILED DESCRIPTION OF THE EXEMPLARY EMBODIMENTS

### Apparatus and Operational Methods

What is described is a system and method for a Customer to create a fully functioning ecommerce business website.

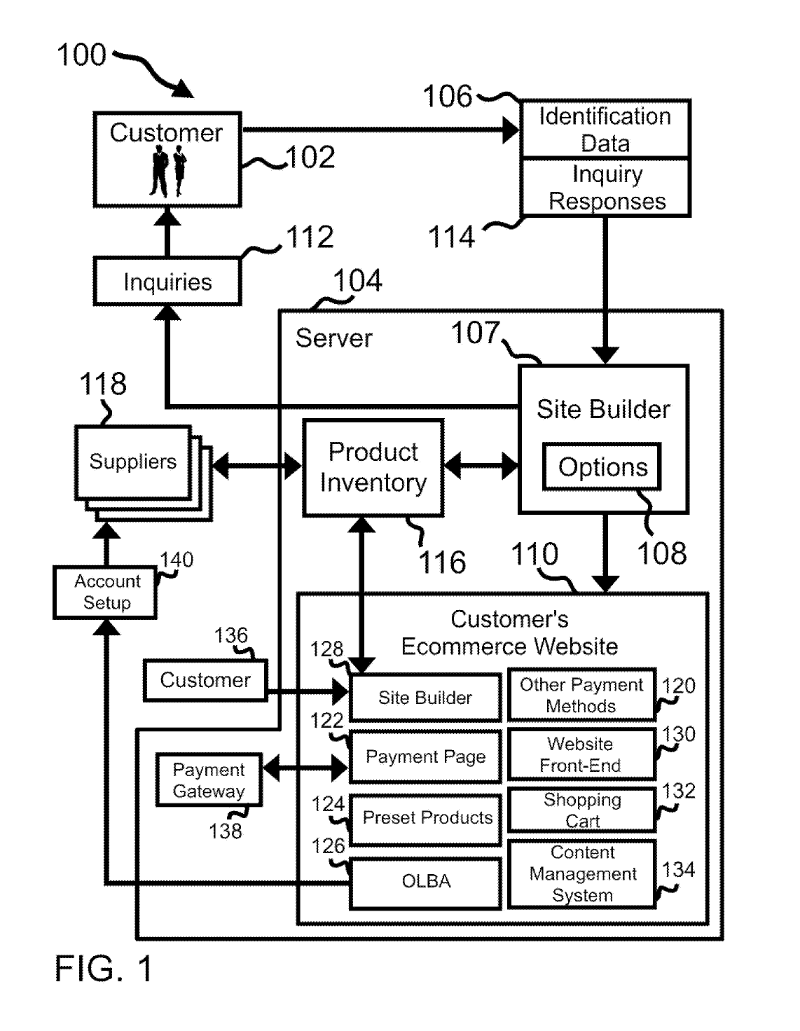

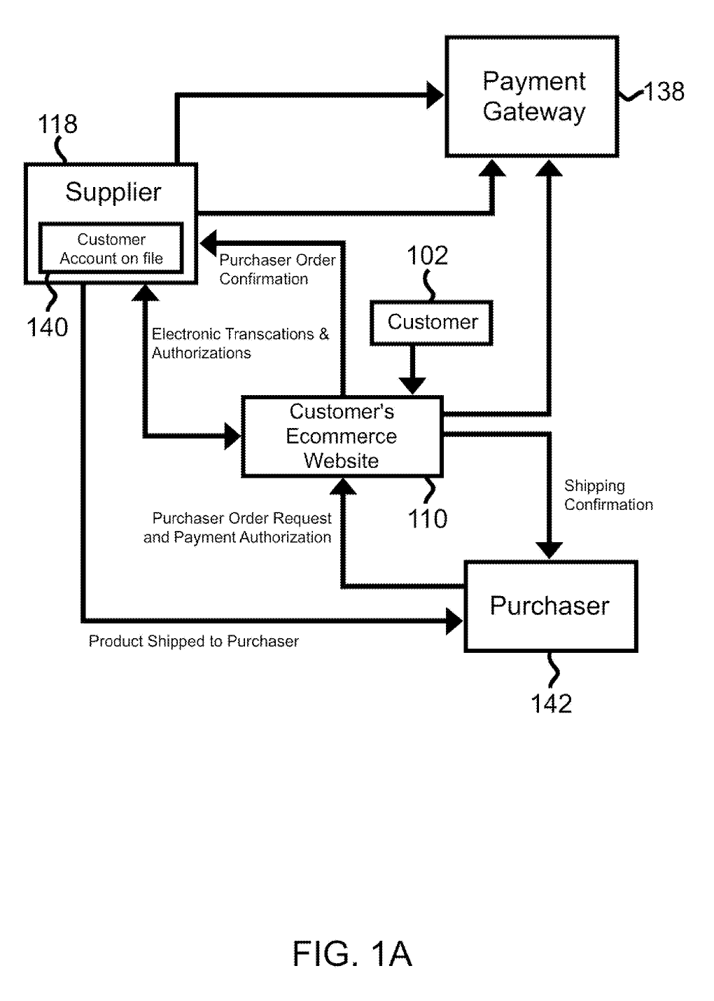

FIG. 1 illustrates a network computer system capable of building an ecommerce website 100 (or any number of ecommerce websites) comprising a Customer 102 on a local computer, smart phone, or other device that acts as a network interface in data communication over a network with a Server 104. The data being sent from Customer 102 includes Identification Data 106 related to the Customer (e.g. the Customer's name, address, phone number, e-mail account, social networking data, products Customer sells, etc.) The Identification Data 106 is stored in the Server 104 and accessible to the Site Builder, 107.

An Options software module 108 inside the Site Builder 107 stores a variety of user selectable options, the selection of options allow the Customer 102 to customize the Customer's Ecommerce Website 110. In one variant the Options module 108 may be located outside the Site Builder 107 but still on the server. In this variant the Options module would be in direct communication with the Customer's Ecommerce Website 110. In one embodiment the Options 108 is programmed to pose Inquires 112 to the Person 102 regarding the content and layout of the Customer's Ecommerce Website 110. The Inquires 112 include, but are not limited to: Type of Business that the ecommerce website is related to (e.g. Automotive, Entertainment, Retail Sales, Services, etc.), Company Logo Image, Contact Information (phone number, email address, etc.), Regional Settings (e.g. Country, Language, Currency, Units of Length, Units of Weight, etc.), and Inventory Settings (e.g. Products to load, Show out of stock warning, show out of stock items, allow checkout with products out of stock, etc.) The Inquiries 112 may prompt the Customer 102 to make a selection from a list of possible response, enter a response, or combination of both. The Customer's Inquiry Responses 114 and Identification Data 106 are loaded into the Site Builder, 107. In one variant, the Identification Data 106 and Inquiry Responses 114 can be loaded on the Server 104 outside the Site Builder 107, but still in data communication with the Site Builder 107.

Suppliers 118 (or even one supplier) or other entities who wish to tender their products for sale, load data into the Product Inventory module 116. It is envisioned that the Suppliers 118 may also be the manufacturer of the products. It is contemplated that this data loading can be done by a computer, smart phone, or other device that acts as a network interface. This data can include the name, description, price, size, weight, category code, and image of a product. For example, a product which is a “Television” would have the Category of “Electronics.” The category code is used by the Site Builder 107 to determine whether to include or exclude the product from the Customer's Ecommerce Website 110. An Inquiry 112 is based in part on the Products Inventory 116 data. (An example would be to Inquire: “Include all products of category?” Inquiry Response: “Electronics” then all Products with the category code of “Electronics” would be loaded into the Site builder 107.)

In another variant, an Inquiry 112 could ask which category of products to not include (e.g exclude all products which are product category: “Clothing.”) Furthermore, in response 114 to an Inquiry 112, the Customer 102 may load data regarding products that the Customer will offer for sale on the Customer's Ecommerce Website 110. This way, the Customer 102 is not limited to sell only the products in the Product Inventory 116. The Options module 108 has inquires designed to obtain the data regarding Customer Products being offered for sale.

After some or all of Inquiry Responses 114 are sent by the Customer 102 to the Site Builder 107, the Customer 102 commands the Site Builder 107 to create the Customer's Ecommerce Website 110.

In one embodiment, the Site Builder comprises two resources. The first resource is a Core File Structure, which comprises the physical assets such as images, code files and folders. During site building, this core structure acts as a master copy and generates websites by cloning the core file structure to a customer specific folder.

The second resource is a Preconfigured Database. The Customer 102 selects from a variety of preconfigured stores. Each preconfigured store has an associated master database file. Each master database has different template-specific information in it such as (color, theme, products, settings, etc.) During website creation the master database file is combined with the customer specific data to create the Preconfigured Database.

The Core File Structure is copied over to a Customer specific folder and accesses the Preconfigured database to create the files that make up the Customer's Ecommerce website 110.

In one embodiment, the Customer's Ecommerce Website 110 includes seven software modules categorized as: Other Payment Methods 120, Payment Page 122, Preset Products 124, On Line Boarding Application (“OLBA”) 126, Site Builder 128, Website Front End 130, Shopping Cart 132, and a Content Management System 134.

The Other Payment Methods 120 is a module designed to interface with third party payment processors such as PayPal®. The Payment Page 122 is a module designed to accept a purchaser's payment information in order to pay for products that have been purchased. The Payment Page 122 establishes the communication with a Payment Gateway 138. The Payment Gateway being located on the Server 104.

The Preset Products 124 is the specific software module that receives and stores the data on products that were loaded into the Customer's Ecommerce Website 110 from Product Inventory 116 via the Site Builder 107. The Preset Product module 124 provides data on all products on the Customer's Ecommerce Website 110 to the other software modules on the Customer's Ecommerce Website 110, including the Shopping Cart 132. The Preset Product module 124 also receives and stores the data on products that were loaded into the Customer's Ecommerce Website 110 from the Inquiry Responses 114.

The OLBA 126 is a software module adapted to receive and load information regarding Customer 102. Furthermore, the OLBA 126 is loaded with a variety of electronic forms, including an On Line Merchant Application, Bank Account Application, Insurance Policy Application, Supplier Agreements, etc. Additional applications can be added to the OLBA after website creation. Customer 102 can select which, if any, application to complete. When the Customer 102 selects an application to complete, depending on the fields of the particular application, some data will be pre-loaded. The Identification Data 106 and Inquiry Responses 114 provided by Customer 102 are used to pre-load fields (e.g. “First Name,” “Last Name” “Address” “Business Type.”) Also, the Preset Products 124 may be used to provide responses to electronic forms from the OLBA 126.

In one variant, OLBA 126 is loaded with an electronic copy of a distribution agreement between a Supplier 118 and the Customer 102. It is contemplated that an executed agreement between the Customer 102 and a Supplier 118 would be returned to Supplier 118 as part of an Account Setup 140, before that Supplier's product would be available for sale on the customer's Ecommerce Website. This restraint would be implemented in a variety of ways, without disabling the Customer's Ecommerce Website, such as showing the Quantity Available for Purchase as “0” for those products supplied by Supplier 118. Another way would to just simply not show the products from the Supplier 118.

The Account Set up 140 can include data regarding the Customer's Credit Card or the Customer's Bank Account, or other data used to facilitate the transfer of funds between Customer 102 and Supplier 118.

The Site Builder 128 module comprises the same code as that of the Site Builder 107. The Site Builder 128 is in data communication with the Product Inventory 116. This data communication allows Customer's Ecommerce Website 110 to be used by another Customer 136 to create another ecommerce website. The growing number of Site Builders can provide, possibly, geometric growth of number of ecommerce websites. In essence it would allow a Customer to create a franchise of ecommerce websites.

The Website Front End 130 comprises those files necessary to generate a web page image when a person navigates to the Customer's Ecommerce Website. Also included with the Customer's Ecommerce Website are a Shopping Card module 132 and a Content Management System 134.

The Customer must then arrange for the purchase of a domain name and point the domain name to the Customer's Ecommerce Website. Every Ecommerce Website mentioned in the disclosure possesses its own URL and domain name.

FIG. 1A is a graphic representation of a drop shipping network. In an embodiment, a Purchaser 142 seeks to purchase a product from the Customer's Ecommerce Website 110. The Customer 102 does not have possession of the product that the Purchaser 142 wishes to purchase. A Supplier 118 has possession of the product. The Customer 102 is acting as a distributor of Supplier's products.

The Purchaser 142 contacts the Customer through Customer's Ecommerce Website 110, (though it is envisioned that contact can be face-to-face, over the phone, teleconference, Skype® or by any other means.) The preferred embodiment is through the Customer's Ecommerce Website 110. The Purchaser 142 pays for the transaction with an electronic payment method such as credit card, pre-paid card, debit card, checks or other electronic payment method. The Customer's Ecommerce Website 110 processes the electronic payment and receives authorization. The Customer receives funds from the Purchaser 142 totaling the amount of the price of the product. In one embodiment a virtual terminal is used to process the electronic payment. Since this is an electronic transaction, the funds are actually moving from Banks used by Purchaser 142 to Merchant Account of Customer 102.

Immediately after Purchaser's electronic payment is authorized, Customer 102 contacts Supplier 118, contact can be face-to-face, over the phone, over the internet, or by any other means. The preferred embodiment of contact is the Customer's Ecommerce Website 110 automatically sends notification with the order confirmation to the Supplier 118. Customer 102 has an account on file 140 with the Supplier 118 to expedite the transaction and make the transaction paperless. The Customer Account 140 may have been previously authorized with an electronic signature. Supplier 118 processes electronic payment transaction. When the Supplier's requested electronic payment is authorized, Supplier receives funds in the amount of the agreed upon price between Supplier and Customer 102. The Supplier 118, then ships to Purchaser 142 the product that Purchaser ordered.

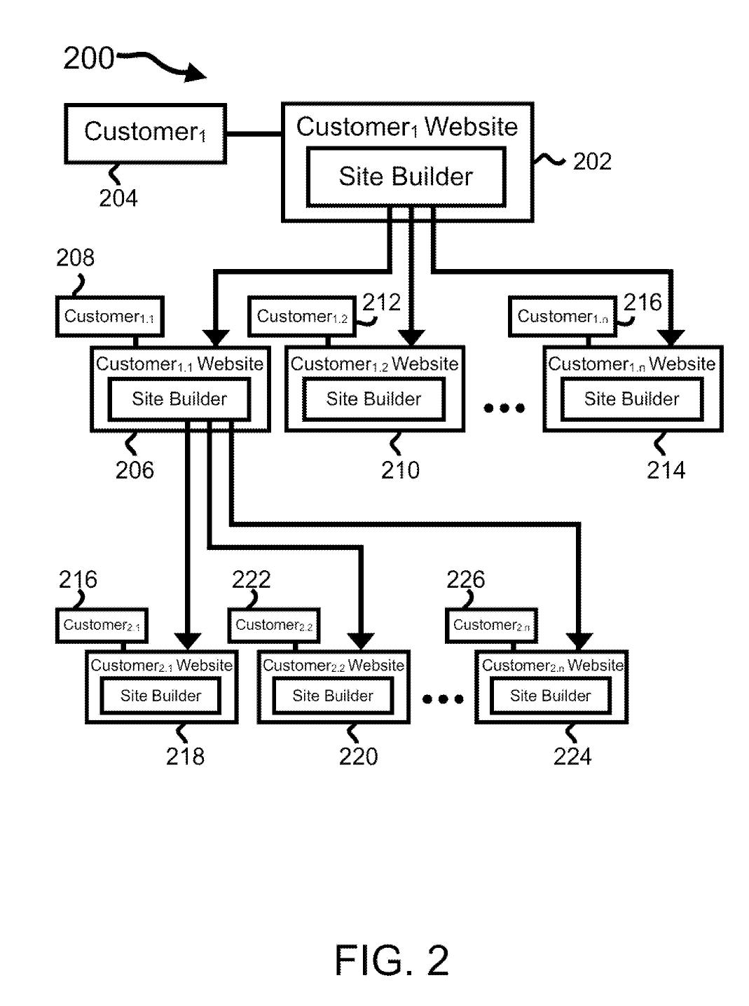

FIG. 2 illustrates a network computer system 200 including multiple websites in data communication on the same server created by using multiple Site Builders from multiple websites. Each website is controlled by a different Customer. (Though not displayed inside each website in FIG. 2, in the preferred embodiment each website possess an Other Payments Methods module, a Payment Page Module, a Present Products Module, an OLBA module, a Website Front-End module, a shopping cart and a content Management system as disclosed above.) The hierarchical nature of the system is evident. The Customer₁ website 202 is controlled by Customer₁, 204. The Site Builder in the Customer₁ website, 202 creates the Customer₁₁ Website 206 (controlled by Customer₁₁, 208), Customer₁₂ Website 210 (controlled by Customer₁₂, 212).

The Site Builder in the Customer₁ website, 202 is capable of creating any number of additional websites. This is characterized by Customer website₁ₙ, 214 (under the control of Customer₁ₙ, 216). Customer₁, 204, controls the number of websites that the Site Builder in website 202 makes.

In one embodiment, Customer₁, 204 initiates the creation of Customer₁₁ Website 206 and relinquishes control of the Customer₁₁ Website 206 to Customer₁₁, 208. In another embodiment, Customer₁₁, 208 initiates the creation of Customer₁₁ Website 206.

The Site Builder in the Customer₁₁ website 206 similarly creates multiple websites (218, 222, 226) for multiple Customers (220, 224, 228) in the same manner as Customer₁ did. Though only three echelons are show in FIG. 2 the system is readily expandable to any number of echelons.

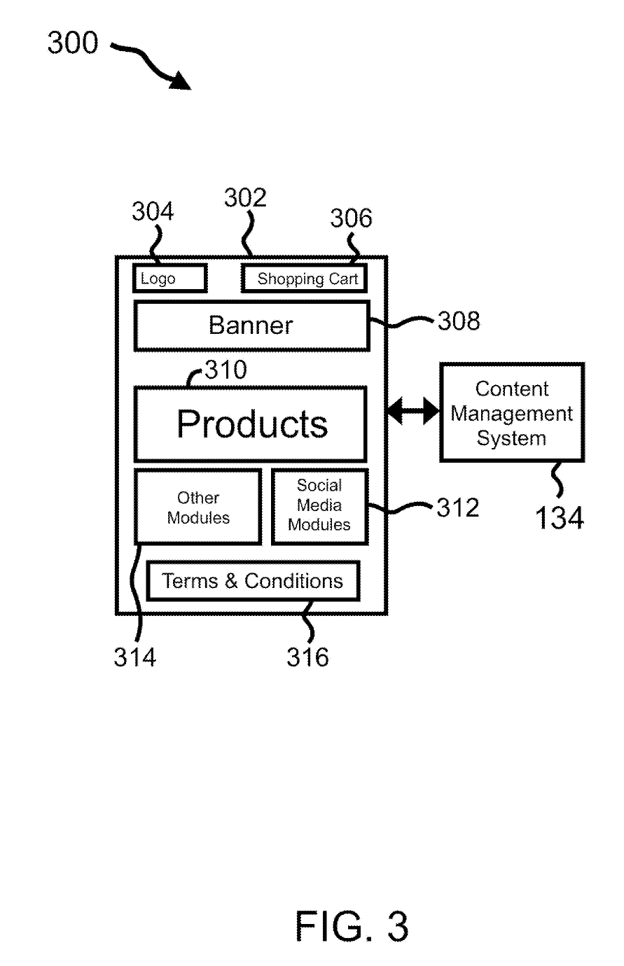

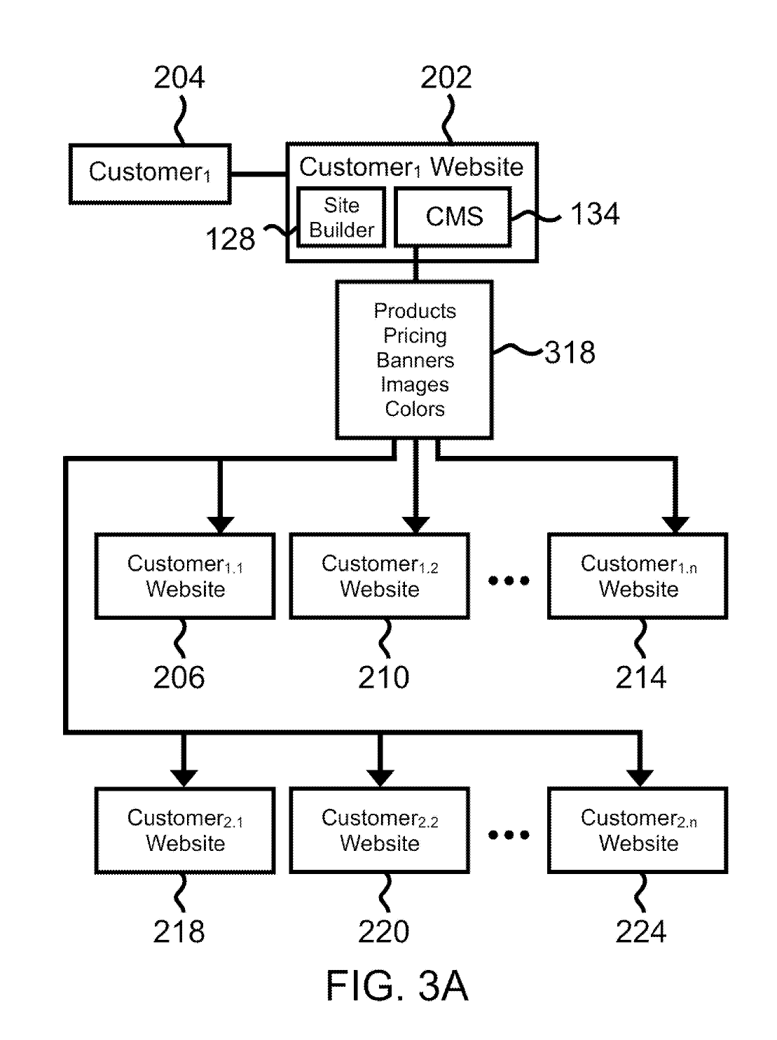

FIG. 3. illustrates a graphical representation of a Content Management System managing the Front-End of a Ecommerce website 300.

The Content Management System 134 provides a Customer tools to manage, adjust, and customize the content and appearance of the Front-End of the Customer's Ecommerce website 302 including, but not limited to: Text, Images, Videos, Music, Products offered for sale, etc.

The Content Management System generates a preview image of the Front End 302 of the Customer's Ecommerce Website 110 on a display so that the Customer 102 can make any desired edits. The Content Management System 134 includes a color picking software module which allows the Customer to customize the colors used in the website.

Also, the Content Management System provides for interchanging of the layout. The template layout in FIG. 3 is the Logo 304 in the upper left corner, the shopping cart link 306 in the upper right corner, the Banner 308 immediately underneath the Logo 301 and Shopping Cart Link 306. Underneath the Banner 308 are Products for sale 310. Under the Products for sale 310 are the Social Media Modules 312, which includes the Customer's feeds from social media websites (e.g. Facebook®, Twitter®) and an “Other” Module 314. The “Other” Module is user selectable from the Content Management System 134. The “Other” Module may be a link to the Customer's E-bay® Store. The information needed to pull the content from the Customer's social media sites and other web-based business is entered by the customer in the Inquiry Responses 114.

The location of the images and links can be moved by the Customer. The Customer may choose to place the Banner 308 at the top of the screen and move the Logo 304 and the Shopping Cart Link 306 to where the Banner 308 was previously located or any other location.

The Company Logo 304 is the image supplied by the Customer 102 as part of the Inquiry Responses 114 which were loaded into the Site Builder 107. In one embodiment, the Content Management System 134 can be used to edit or modify a logo. In the case where a Customer does not have a logo during the website building process, the Content Management system 134 can be used to add it after the website is built. Similarly, the Content Management System 134 can add products available for sale that were not initially loaded onto the website.

The Shopping Cart link 306 allows a visitor to the Ecommerce Website to be shown an image of the Shopping Cart, including those products which have been selected for purchase. The Banner 308 is a Customer picked image, message or a combination of images and messages. Products 310 are images of products included as part of the data from the Preset Products 124, and/or Customer Inquiry Responses 114.

The text from a Terms & Conditions statement 316 is preloaded, but can be changed per the Customer's desires. The entire text may be edited, typical edits include the days which a customer may return an item, whether the return is for store credit or cash, etc.

FIG. 3A is a graphic representation of a network hierarchy of ecommerce business which all trace their lineage back to a single website. Customer₁ 204, creates the Customer website₁ 202. The Site Builder 128 creates the Customer Websites 206, 210, and 214. The Site Builder in the Customer_{1,1} Website creates Customer Websites 218, 220, and 224.

During the website creation process, data defining the location on the server where the files comprising the Customer Websites 206, 210, 214, 218, 220, and 224 files was stored on the Content Management System 134.

Under the control of Customer₁, the Content Management System 134 can update/modify/delete/add content 318 such as Products for sale, prices of product, Banner images, color schemes, etc. to the Customer Websites 206, 210, 214, 218, 220, and 224. Customer₁ 204 may choose to only update content regarding a product being sold, e.g. reduce the price of a product by ten dollars. The updated product price is sent to the six Customer Websites 206, 210, 214, 218, 220, and 224. All other content on the six Customer websites is unchanged.

In another embodiment, Customer₁ may choose to update much of the content on the Customer websites e.g. 20% off of all products being sold, a change in the Banner message announcing the 20% reduction, a new company logo and a new color scheme and on and on. To take that embodiment to the extreme, Customer₁ can update all of the content on the six Customer Websites 206, 210, 214, 218, 220, and 224. This would create identical websites, which vary only by the domain name or URL.

In another embodiment, the Content Management System, 320 sends commands to the Content Management System of each of the six Customer Websites 206, 210, 214, 218, 220, and 224 to update/modify/delete/add content. The Content Management System in each of the Customer Websites updates the content for that particular website based on the commands received.

In still one variant, the Site Builder 128, can create content that may only be edited by the Content Management System 134. The Site Builders in each of the six Customer Websites 206, 210, 214, 218, 220, and 224 may copy the content, but not update/modify/delete the content. An example of this embodiment would be a corporate headquarters loading the corporate logo on the front page of its corporate website. The corporate logo would remain unchanged in every website whose lineage is traced back to the corporate website. This is to say that the regional or local websites can modify other content except the corporate logo.

Although only three layers and six websites were shown in FIG. 3A, any number of websites in any number of layers (e.g. Corporate, Regional, State, Local would be four layers) can be practiced.

While the above detailed description has shown, described, and pointed out novel features applied to various embodiments, it will be understood that various omissions, substitutions, and changes in the form and details of the device illustrated may be made by those skilled in the art without departing from the disclosure. The foregoing description is of the best mode presently contemplated. This description is in no way meant to be limiting, but rather should be taken as illustrative of the general principles disclosed. The scope of the invention should be determined with reference to the claims.

### Methods of Processing Documents

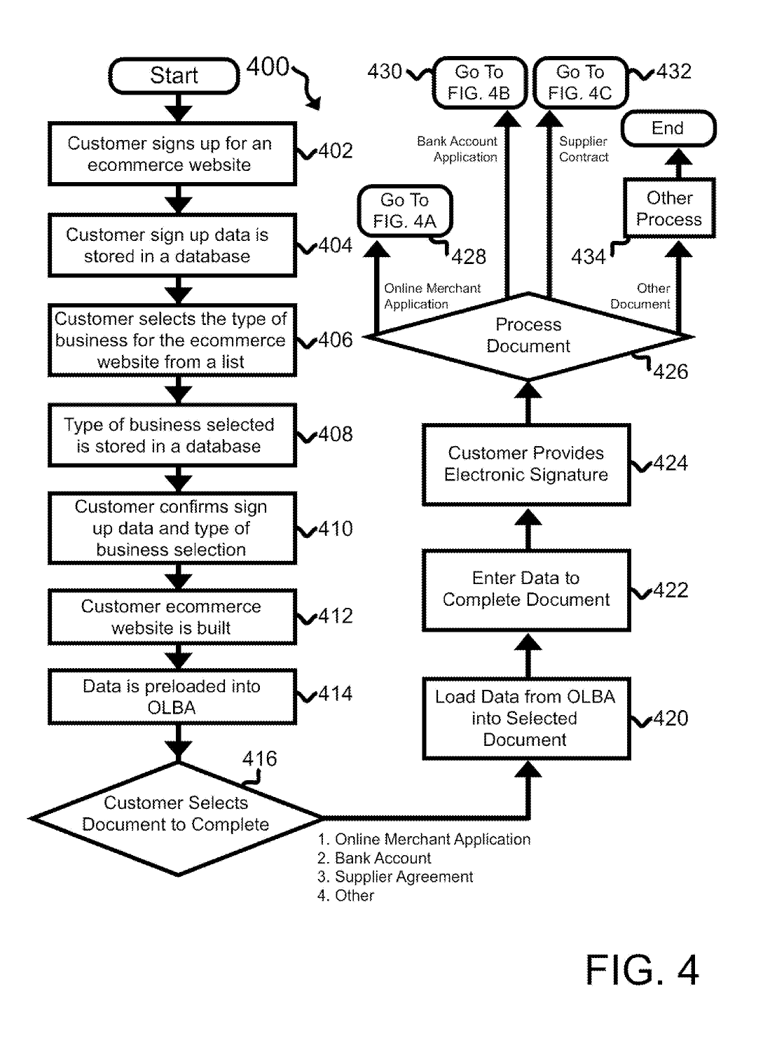

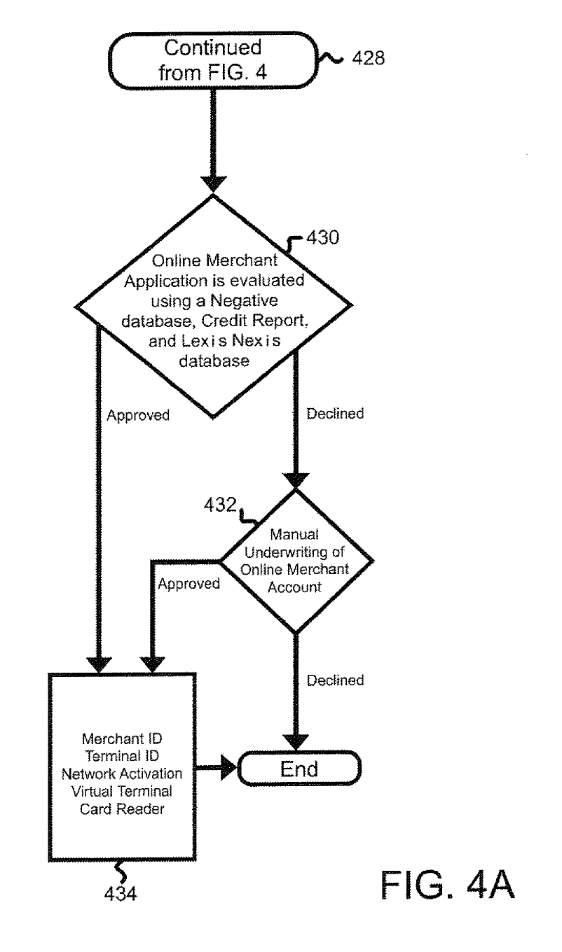

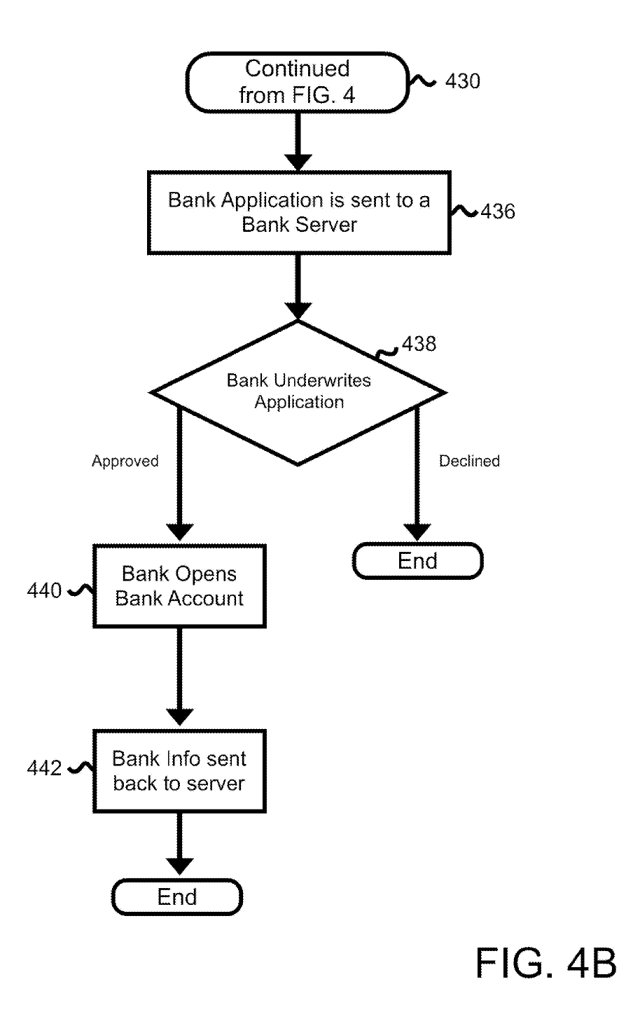

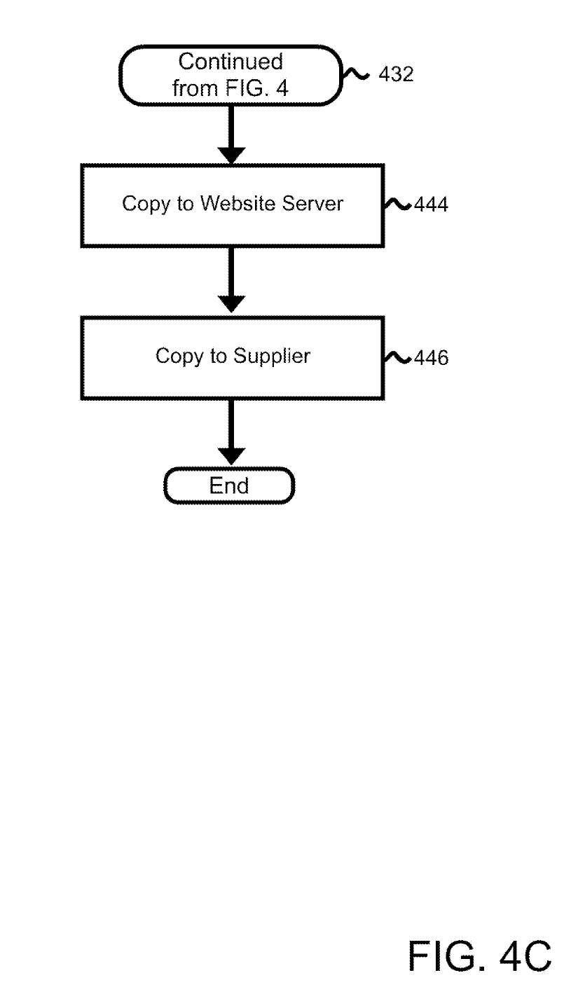

Methods of doing business relating to the aforementioned apparatus and operational methods are illustrated with the assistance of FIG. 4. FIG. 4 shows a flow chart 400 representing a method for document processing related to newly created ecommerce business website. A customer visits a website and signs up to obtain an ecommerce website 402. It is contemplated that the customer may be purchasing the website or signing up for a limited trial offer, or may even have the website sign-up gifted to him. Sign-up data includes, but not limited to the customer's first name, last name and e-mail address. The sign-up data is stored on a database 404. The customer selects the type of business that will be supported by the ecommerce website being created 406. The type of business selected is stored on a database 408. The customer confirms the sign-up data and type of business that has been selected 410. Once the confirmation is completed, the ecommerce website is built 412 using, among other data, the sign-up data and data associated with the type of business that has been selected. The ecommerce website contains an On Line Boarding Application (OLBA) which is a software module designed to accept data stored on a database related to the customer and populate fields from various applications (e.g. bank account application, insurance application, merchant account application, credit card application, supplier agreement, etc.) with the customer data. It is envisioned that other documents, not just applications, can be loaded into the OLBA for use by a Customer who just formed a new ecommerce business. Data is preloaded into the OLBA 414.

The Customer selects which document to complete 416. Data from the OLBA is then loaded into the selected document 420. If the OLBA does not have all of the data necessary to complete a document, the customer enters additional data to complete the selected document 422. The customer completes the document by providing an electronic signature 424. Depending on the document selected, the processing process varies 426. This process is readily adaptable to documents not yet in existence. The “Other Process” 434 is shown to capture the readily expandable nature of this process to “Other Documents.”

Referring now to FIG. 4A. The document processing of an Online Merchant Application (OLMA) is continued 428 from the process that began being described in FIG. 4. Data in the completed OLMA is used to evaluate the worthiness of the customer to receive a merchant account. Prior to forming the ecommerce business, the customer would have had a lower score, than the customer has at the time of evaluation since the customer's ecommerce business offers for sale a variety of products. The customer's data is cross referenced with a negative database and Lexus Nexus® 430. The customer's a credit report is then requested from a credit reporting agency. Based on the analysis of preset criteria, the OLMA is either approved or declined.

A declined OLMA is evaluated manually by a person 432. If the manually evaluated OLMA is declined, then the customer's OLMA is not reviewed again. If the manually evaluated OLMA is approved or if the OLMA is approved based on the analysis of preset criteria, the customer receives a merchant account 434.

The customer receives a Merchant Identification and a Terminal Identification number for use in processing electronic payments. With a Merchant Identification Number and a Terminal Identification number, the customer can successfully use either a virtual terminal or a card reader to process, among other transactions, credit card transactions.

Referring now to FIG. 4B. The document processing of a bank account is continued 430 from the process that began being described in FIG. 4. The bank application is sent to a Bank Server which is designed to accept online applications. The bank conducts its own underwriting to determine if the customer's application is acceptable 438. If the bank declines the application, no further action is taken. If the Bank approves the application, the Bank opens a bank account 440. The specific data regarding the bank account is sent back to the server to the server 442 to provide feedback to the customer/applicant. This feedback will include at least the bank account name and the bank routing number. The feedback will also be integrated into the customer's ecommerce website to facilitate future business transactions. The feedback is loaded back to the OLBA and can be used to populate fields related to the customer's bank account or to provide data on a subsequent bank account if the customer has already input data regarding a prior existing bank account.

Referring now to FIG. 4C. The document processing of a supplier agreement is continued 432 from the process that began being described in FIG. 4. The supplier agreement is related to the type of business selected for the ecommerce website 406. The fully executed agreement is sent back to the customer's website server 444 and from there a copy is sent to the supplier 446. Though the agreement can cover any topic related to the two parties, it is contemplated the agreement will at least describe a drop-shipping arrangement between the supplier and the customer.

It will be appreciated that while certain aspects are described in terms of a specific sequence of steps of a method, these descriptions are only illustrative of the broader methods disclosed, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claimed herein.

1. Network apparatus configured to create Ecommerce websites for customers in communication therewith, the network apparatus comprising:
a first network interface in data communication with a server;
a second network interface in data communication with said server; and
a third network interface in data communication with said server via a first Ecommerce website;
wherein said server is configured to:
receive via said first network interface data input by a first customer, the first network interface data relating to a content and/or layout of said first Ecommerce website, said first customer having control over said first Ecommerce website via a first content management system;
receive via said second network interface data input by at least a first supplier, the second network interface data input relating to products said at least first supplier is offering for sale, said first supplier having no control over said first Ecommerce website;
receive via the third network interface data input by a second customer, the third network interface data relating to a content and/or layout of a second Ecommerce website;
wherein said server comprises:
a product inventory module adapted to receive, store and transmit said second network interface data related to products said at least first supplier is offering for sale; and
a first site builder module adapted to create at least one Ecommerce website hosted on said server said first Ecommerce website; and
wherein said first Ecommerce website comprises:
a first On-Line Boarding Application (OLBA) module, said first OLBA module configured to produce at least a first document, said first document comprising an agreement between said first customer and said first supplier to establish a business arrangement between said first customer and said first supplier; and
a first preset product data module, said first preset product data module being related to said data input by said first customer and said data related to products that said at least first supplier is offering for sale.

2. The Network Apparatus of claim 1, wherein said first Ecommerce website comprises:
a second site builder module adapted to create at least an Ecommerce website hosted on said server, said second site builder module in data communication with said product inventory module;
a first payment page;
a first website front end; and
a first shopping cart.

3. (canceled)

4. A method of creating ecommerce websites, the method comprising:
providing, via a processor on a server, a first person with a first website, wherein said first website comprises a first website building module capable of creating at least another website, via said processor;
using said first website building module of said first website to create at least a second website, wherein said second website includes a portion of data from said first website and a second website building module capable of creating at least another website;
giving control of said second website to a second person;
receiving sign up data from said second person;
storing said sign up data in a database;
providing said second person a listing of business types said website is based upon; receiving a selection from said second person of a business types based on said provided listing of business types;
loading data comprising said sign up data into an On Line Boarding Application (OLBA) database;
providing said second person a listing of applications said second person would like to complete;
receiving a selection from said second person of at least one application of said listing of applications said second person would like to complete;
pre-populating at least one application associated with said selection of said at least one application of said listing of applications said second person would like to complete utilizing said data loaded in said OLBA database;
requesting additional data from said second person based on said at least one application and said data loaded in said OLBA database to complete said at least one application; and
receiving an electronic signature from said second person.

5. The method of claim 4 further comprising:
using said second website building module to create at least a third website, wherein said third website includes a portion of content from said second website and a third website building module capable of creating at least another website; and
giving control of said third website to a third person.

6. The method of claim 4 wherein said portion of data from said first website comprises product inventory data.

7. The method of claim 4 wherein said portion of data from said first website comprises a shopping cart.

8. The method of claim 4 wherein said portion of data from said first website comprises an image file.

9. A method of updating content on a system of Ecommerce websites located on the a same server, the method comprising:
creating a first website, wherein said first website includes a software module capable of creating a plurality of other websites, each of said plurality of other websites comprising a separate domain and associated with a separate owner;
creating said plurality of other websites, via a processor on said same server, wherein data defining a location of files making up said plurality of other websites are collocated with files of said first website;
using a content management system associated with said first website to update content on said first website; and
updating each of said plurality of other websites via said content management system associated with said first website.

10. The method of claim 9, wherein said first website has a first uniform resource locator (URL); and
said at least second website has a second URL.

11.-17. (canceled)

18. The method of claim 9, wherein said content comprises pricing of product inventory and said updating each of said plurality of other websites comprises updating a price of a product on said plurality of other websites.

19. The method of claim 9, wherein said content comprises products in a product inventory, and said updating each of said at least one of said plurality of other websites comprises updating said product inventory to include a new product on said plurality of other websites.

20. The method of claim 9:
wherein creating said plurality of other websites comprises preloading a terms and conditions statement onto each of said plurality of other websites; and
said method further comprises updating said terms and conditions statement of one of said plurality of other websites based on input received from said separate owner of said one of said plurality of other websites.

21. The method of claim 4, further comprising:
determining that said at least one application comprises an Online Merchant Application (OLMA);
based at least in part on said determining, cross referencing said OLMA with at least one database and credit report of said second person;
determining that said OLMA is automatically approvable via an analysis of said cross referencing; and
based at least in part on said determination, sending a merchant identification and a terminal identification number to said second person for processing electronic payments.

22. The method of claim 4, further comprising:
determining that said at least one application comprises a bank account application;
based at least in part on said determining, sending said bank account application to a server associated with a bank;
receiving approval information from said bank comprising said bank account name and a bank routing number; and
integrating said approval information into said second website and said OLBA.

23. The method of claim 4, further comprising:
determining that said at least one application comprises a supplier agreement; and
based at least in part on said determining, sending a copy of said supplier agreement to a supplier, said supplier agreement describing a drop-shipping arrangement between said second person and said supplier.
